(19) United States
(12) Patent Application Publication
(10) Pub. No.: US 2022/0041821 A1
(43) Pub. Date: Feb. 10, 2022

(54) Polyimide Film and Flexible Display Panel Including the Same

(71) Applicants: SK Innovation Co., Ltd., Seoul (KR); SK ie technology Co., Ltd., Seoul (KR)

(72) Inventors: Min Sang Park, Daejeon (KR); Sun Kug Kim, Daejeon (KR); Jin Su Park, Daejeon (KR); Hyun Joo Song, Daejeon (KR); Seung Min Jeon, Daejeon (KR)

(21) Appl. No.: 17/394,590

(22) Filed: Aug. 5, 2021

(30) Foreign Application Priority Data
Aug. 6, 2020 (KR) 10-2020-0098616

(51) Int. Cl. C08J 5/18; G09F 9/30; C08G 73/10

(52) U.S. Cl. CPC C08J 5/18; C08J 2379/08; C08G 73/1007; G09F 9/301

(57) ABSTRACT

Provided are a polyimide-based film, a window cover film, and a display device including the same. More particularly, a polyimide-based based film which has a modulus of 5 GPa or more as measured using a universal testing machine (UTM) in accordance with ASTM D882, plastically deforms at a strain of 4% or more during stretching, and has a difference between a modulus in a machine direction Mmd and a modulus in a width direction Mtd satisfying the following Equation 1, is provided:

|Mmd−Mtd|≤0.7 GPa. [Equation 1]

### CROSS-REFERENCE TO RELATED APPLICATION

This application claims priority to Korean Patent Application No. 10-2020-0098616 filed Aug. 6, 2020, the disclosure of which is hereby incorporated by reference in its entirety.

### BACKGROUND OF THE INVENTION

### Field of the Invention

The following disclosure relates to a polyimide-based film, a window cover film, and a display panel including the same.

More particularly, the following disclosure relates to a polyimide-based film which solves a problem of leaving marks in a folded part when the film is maintained in a state of being folded for a long time and then unfolded, a window cover film, and a display panel including the same.

### Description of Related Art

A thin display apparatus is implemented in the form of a touch screen panel and is used in various smart devices including various wearable devices as well as smart phones and tablet PCs.

The touch screen panel-based displays are provided with a window cover made of tempered glass on a display panel for protecting the display panel from scratches or external shock.

However, in recent years, since the tempered glass is not suitable for weight lightening and is vulnerable to external shock, a technology for an optical plastic film having strength or scratch resistance corresponding to that of the tempered glass together with flexibility and impact resistance has been developed.

As these plastic materials, polyethylene terephthalate (PET), polyether sulfone (PES), polyethylene naphthalate (PEN), polyacrylate (PAR), polycarbonate (PC), polyimide (PI), polyaramide (PA), and the like are used.

In general, a polymer has a nature of visco-elastic property. The nature of an elastic body (elastic deformation) is shown in a fine deformation section, but when the deformation is increased, plastic deformation is shown due to the nature of a viscous body. Here, when the elastic property of the polymer is large, the polymer may have high modulus and strength but has a low elongation. However, when the viscous nature is large, the polymer shows a high elongation but has low modulus and strength, thereby having weak mechanical strength.

An optical film applied to a window cover film of a foldable display and a flexible display is required to have high mechanical strength for replacing glass, and also should not leave marks even when being maintained in a deformed state such as being folded and bended.

Accordingly, the physical property of not leaving marks when a device having a film for a window cover film is maintained in a state of being folded for a long time and then is unfolded, is required.

### RELATED ART DOCUMENTS

### Patent Documents

(Patent Document 1) Korean Patent Laid-Open Publication No. 10-2017-0028083 A (Mar. 13, 2017)

### SUMMARY OF THE INVENTION

An embodiment of the present invention is directed to providing a polyimide-based film for being applied to a window cover film of a flexible display, which, when being fixed to a folding tester (YUASA SYSTEMS CO., LTD.) using an adhesive, folded in a state of setting a folding radius (R₁ of FIG. 1) to 3 mm, maintained at 25° C./50% RH for 240 hours, and then unfolded, the area where the film was folded is not folded again in the folded part, may return to its original state with minimized deformation, and has a small change in optical physical properties.

In general, when an optical film composed of an organic material is deformed to a section where plastic deformation occurs and then maintained in a state of being given constant stress, the polymer is not restored to its original state even when the stress is removed. This may cause a problem of leaving marks without being restored to its original state, when a device having a window cover film is maintained in a state of being folded for a long time and then unfolded, and thus, is particularly important in the physical properties of a window cover film for a flexible display.

Accordingly, as a result of conducting a study for solving the problem, it was found in the present invention that by adjusting a stress size applied to a film and a stress-relaxation degree in a film production process, a modulus size in the film and a strain causing plastic deformation are adjusted to achieve the above object.

More specifically, as an example, a stress size applied to a film and a stress-relaxation degree may be adjusted by adjusting stretching and heat setting steps, and it was found by the means that when a modulus is 5.0 GPa or more, plastic deformation occurs at a strain of 4% or more during stretching, and a difference between MD and TD moduli is 0.7 GPa or less, the effect intended in the present invention may be obtained, thereby completing the present invention.

In addition, it was found in the present invention that when a stress at the time of occurrence of plastic deformation is 1000 kgf/cm² or more, the effect of the present invention may be further increased, thereby completing the present invention.

In addition, an amount of energy required per a unit thickness μm of the polyimide-based film may be 30 J/m²/μm or more, more specifically 30 to 100 J/m²/μm, and more specifically 35 to 60 J/m²/μm, at a point where plastic deformation occurs, in a stress-strain curve measured using a universal testing machine (UTM). In the range, a film having a better restoring force even after being folded for a long time may be provided.

When a film satisfying the physical properties may be obtained, without being limited to the production method and the means, as an exemplary embodiment, first, the transparent polyimide solution of the present invention is used to perform casting on a substrate, and then the film is peeled off from the substrate in a state in which 15 to 30 wt % of a residual solvent remains by first drying.

Subsequently, the peeled off film is stretched to 1.01 to 1.5 times in a MD direction (film progress direction) at a temperature of 150° C. or lower, and then is secondarily dried by drying it again in a drying chamber to dry the solvent to a content of 5 wt % or less, preferably 3 wt % or less, and more preferably 0.5 wt % or less. Here, it is preferred that the drying temperature is maintained at 150° C. to 300° C. During the second drying, a step of fixing the film using a jig in the form of a clip or pin for suppressing contraction in a TD direction (a direction perpendicular to a film progress direction), thereby imparting a stretching effect in a TD direction, is performed. Subsequently, the film having the effect of being stretched is heat-treated at around a temperature of glass transition temperature (T_{g})±30° C. for 10 seconds to 10 minutes, thereby producing a polyimide film having the properties of the present invention.

Accordingly, the film of the present invention is a transparent polyimide-based film having a high modulus and causing plastic deformation at a high strain, and may be used as a window cover film for foldable and flexible devices which, when being maintained in a state of being folded for a long time and then unfolded, shows significantly improved restoration to its original state.

In addition, the polyimide-based film having an adjusted creep property according to the present invention may have high pencil hardness and dynamic bending property and durability.

Other features and aspects will be apparent from the following detailed description, the drawings, and the claims.

### BRIEF DESCRIPTION OF THE DRAWING

FIG. 1 is a schematic drawing illustrating a folded state of a window cover film according to an exemplary embodiment of the present invention.

### DESCRIPTION OF THE INVENTION

Hereinafter, the present invention will be described in more detail. However, the following exemplary embodiment is only a reference for describing the present invention in detail, and the present invention is not limited thereto and may be implemented in various forms.

In addition, unless otherwise defined, all technical terms and scientific terms have the same meanings as those commonly understood by one of those skilled in the art to which the present invention pertains. The terms used herein are only for effectively describing a certain specific example, and are not intended to limit the present invention.

In addition, the singular form used in the specification and claims appended thereto may be intended to also include a plural form, unless otherwise indicated in the context.

In the present invention, polyimide is used as a term including polyimide or polyamide-imide.

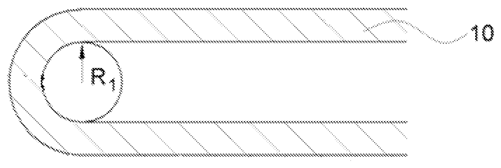

The inventors of the present invention developed a film, which, as shown in FIG. 1, when being fixed to a folding tester (YUASA SYSTEMS CO., LTD.) using an adhesive, maintained at 25° C./50% RH for 240 hours in a state of being folded with a folding radius (R₁ of FIG. 1) set to 3 mm, and then unfolded, may return to its original state without being folded again in the folded part or causing deformation, and has a less change in optical physical properties. The deformation means that when a folded part is unfolded on a flat floor, the folded part is bent or folded again, or the folded part has an optical stain or blurry haze occurs.

In addition, the film of the present invention has a modulus in accordance with ASTM D882 of 5 GPa or more and plastically deforms at a strain of 4% or more during stretching, and when a difference between a modulus in a machine direction Mmd and a modulus in a width direction Mtd satisfies the following Equation 1, the film may show a better restoring force, which is thus preferred. Specifically, in the following Equation 1, it is preferred that the difference is 0.7 GPa or less, 0.4 GPa or less, 0.3 GPa or less, and more specifically 0.2 GPa or less. A lower limit is not limited, but may be 0.

|Mmd−Mtd|≤0.7 GPa [Equation 1]

A border between elasticity and plasticity is determined by defining a point where a differential slope in S-S curve is decreased by 75% relative to a stress-strain slope in an initial elasticity section (0% to 0.5% strain section) as a plastic section.

In addition, a polyimide-based film having a total light transmittance of 87% or more as measured at 400 to 700 nm in accordance with ASTM D1746, a light transmittance of 5% or more as measured at 388 nm in accordance with ASTM D1746, a haze of 2.0% or less, and a yellow index of 5.0 or less is more preferred.

In the range satisfying all of the physical properties, the film may be applied to a window cover film, has an excellent restoring force to return to its original state even after being folded for a long time, and has excellent optical physical properties even after being folded, thereby providing a window cover film appropriate for a flexible display.

In addition, an amount of energy required per a unit thickness μm of the polyimide-based film may be 30 J/m² or more, more specifically 30 to 100 J/m², at a point where plastic deformation occurs, in a stress-strain curve measured using a universal testing machine (UTM). In the range, a film having an excellent restoring force even after being folded for a long time may be provided, which is thus preferred.

In addition, a stress of the polyimide-based film at a point where plastic deformation occurs may be 1000 kgf/cm² or more, more specifically 1000 to 3000 kgf/cm².

In addition, as a method of producing a polyimide-based film satisfying all of the physical properties, though the means is not particularly limited in the present invention, as an example of the means achieving the object, drying conditions, stretching conditions, and heat treatment conditions are adjusted using the transparent polyimide of the present invention, and the content of the solvent in each step is adjusted to change a creep property, thereby obtaining the physical properties of the present invention.

As an example of one specific means, a polyimide-based resin solution of the present invention is cast, the film is peeled off in a state of a residual solvent being 15 to 30 wt %, stretched finely in an MD direction at a temperature of 150° C. or lower, tightly fixed with a clip in a TD direction while being secondarily dried not to be contracted and stretched, thereby imparting a stretching effect, and subsequently, the film is heat-treated at a glass transition temperature (T_{g})±30° C. near a glass transition temperature, thereby producing a polyimide film having a restoring force characteristic of the present invention.

Hereinafter, this will be described in more detail, as an example.

<Polyimide-Based Film>

In an exemplary embodiment of the present invention, a thickness of the polyimide-based film may be 10 to 500 μm, 20 to 250 μm, or 30 to 100 μm.

In an exemplary embodiment of the present invention, the polyimide-based film may be a polyimide-based resin, and, in particular, a polyimide-based resin having a polyamide-imide structure.

Preferably, the polyimide-based film may be a polyamide-imide-based resin including a fluorine atom and an aliphatic cyclic structure, and the physical properties of the present invention may be achieved by subjecting the resin to the drying, stretching, and heat treatment conditions of the present invention, and thus, better mechanical physical properties and dynamic bending properties may be achieved.

In an exemplary embodiment of the present invention, the polyamide-imide-based resin including a fluorine atom and an aliphatic cyclic structure may include a unit derived from a fluorine-based aromatic diamine, a unit derived from an aromatic dianhydride, and a unit derived from an aromatic diacid dichloride.

More preferably, in an exemplary embodiment of the present invention, as the polyamide-imide-based resin including a fluorine atom and an aliphatic cyclic structure, it is preferred to use a quaternary copolymer including a unit derived from a fluorine-based aromatic diamine, a unit derived from an aromatic dianhydride, a unit derived from a cycloaliphatic dianhydride, and a unit derived from an aromatic diacid dichloride, since it is more appropriate for expressing the physical properties to be desired.

In an exemplary embodiment of the present invention, as an example of the polyamide-imide-based resin including a fluorine atom and an aliphatic cyclic structure, a polyamide-imide polymer is preferred, which is prepared by preparing an amine-terminated polyamide oligomer derived from a first fluorine-based aromatic diamine and an aromatic diacid dianhydride and polymerizing the amine-terminated polyamide oligomer with monomers derived from a second fluorine-based aromatic diamine, an aromatic dianhydride, and a cycloaliphatic dianhydride, since the object of the present invention is achieved better.

The first fluorine-based aromatic diamine and the second fluorine-based aromatic diamine may be the same or different kinds. More specifically, an exemplary embodiment of the polyamide-imide-based resin may include a block consisting of an amine-terminal polyamide oligomer derived from a first fluorine-based aromatic diamine and an aromatic diacid dichloride and a polyimide unit at both ends, and a content of the block may be 50% or more, based on the mass.

In an exemplary embodiment of the present invention, when the amine-terminated oligomer having an amide structure in a polymer chain formed by the aromatic diacid dichloride is included as the monomer of the diamine, not only optical physical properties but also in particular, mechanical strength including the modulus may be further improved, and also the dynamic bending properties may be further improved.

In an exemplary embodiment of the present invention, when the polyamide oligomer block is included as described above, a mole ratio between a diamine monomer including the amine-terminated polyamide oligomer and the second fluorine-based aromatic diamine and a dianhydride monomer including the aromatic dianhydride and the cycloaliphatic dianhydride of the present invention may be 1:0.9 to 1.1, specifically at a mole ratio of 1:1.

In addition, a content of the amine-terminated polyamide oligomer with respect to the entire diamine monomer is not particularly limited, but it is preferred to include 30 mol % or more, specifically 50 mol % or more, and more specifically 70 mol % or more of the amine-terminated polyamide oligomer for satisfying the mechanical physical properties, the yellow index, and the optical properties of the present invention.

In addition, a composition ratio of the aromatic dianhydride and the cycloaliphatic dianhydride is not particularly limited, but a ratio of 30 to 80 mol %:70 to 20 mol % is preferred considering the transparency, the yellow index, and the mechanical physical properties of the present invention, but the present invention is not necessarily limited thereto.

In addition, another example of the polyamide-imide-based resin including a fluorine atom and an aliphatic cyclic structure in the present invention may be a polyamide-imide-based resin obtained by mixing, polymerizing, and imidizing the fluorine-based aromatic diamine, the aromatic dianhydride, the cycloaliphatic dianhydride, and the aromatic diacid dichloride.

The resin has a random copolymer structure, may include 40 mol or more, specifically 50 to 80 mol of the aromatic diacid dichloride, 10 to 50 mol of the aromatic dianhydride, and 10 to 60 mol of the cyclic aliphatic dianhydride with respect to 100 mol of the diamine, and may be prepared by performing polymerization at a mole ratio of the sum of the diacid dichloride and the dianhydride to the diamine monomer of 1:0.9 to 1.1, specifically 1:1, but the present invention is not necessarily limited thereto.

The random polyamide-imide of the present invention is somewhat different from the block-type polyamide-imide resin in the optical properties such as transparency, the mechanical physical properties, and solvent sensitivity due to a surface energy difference, but may belong to the category of the present invention.

In an exemplary embodiment of the present invention, as the fluorine-based aromatic diamine component, a mixture of 2,2′-bis(trifluoromethyl)-benzidine and another known aromatic diamine component may be used, or 2,2′-bis(trifluoromethyl)-benzidine may be used alone. By using the fluorine-based aromatic diamine as such, excellent optical properties may be further improved and the yellow index may be further improved, based on the mechanical physical properties required in the present invention, as the polyamide-imide-based film. In addition, the tensile modulus of the polyamide-imide-based film may be improved to further improve the mechanical strength and to further improve the dynamic bending property.

As the aromatic dianhydride, at least one or two or more of 4,4′-hexafluoroisopropylidene diphthalic anhydride (6FDA), biphenyltetracarboxylic dianhydride (BPDA), oxydiphthalic dianhydride (ODPA), sulfonyl diphthalic anhydride (SO2DPA), (isopropylidenediphenoxy) bis(phthalic anhydride) (6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis(carboxyphenyl) dimethylsilane dianhydride (SiDA), and bis(dicarboxyphenoxy) diphenyl sulfide dianhydride (BDSDA) may be used, but the present invention is not limited thereto.

As an example of the cycloaliphatic dianhydride, any one or a mixture of two or more selected from the group consisting of 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclo[2.2.2]oct-7-en-2,3,5,6-tetracarboxylic dianhydride (BTA), bicyclooxtene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride (TMDA), 1,2,3,4-tetracarboxycyclopentane dianhydride (TCDA), and derivatives thereof may be used.

In an exemplary embodiment of the present invention, when the amide structure in the polymer chain is formed by the aromatic diacid dichloride, not only the optical physical properties but also the mechanical strength particularly including the modulus may be further greatly improved.

As the aromatic diacid dichloride, any one or a mixture of two or more selected from the group consisting of isophthaloyl dichloride (IPC), terephthaloyl dichloride (TPC), [1,1′-biphenyl]-4,4′-dicarbonyl dichloride (BPC), 1,4-naphthalene dicarboxylic dichloride (NPC), 2,6-naphthalene dicarboxylic dichloride (NTC), 1,5-naphthalene dicarboxylic dichloride (NEC), and derivatives thereof may be used, but the present invention is not limited thereto.

Hereinafter, taking a case of producing a block polyamide-imide film as an example, each step will be described in more detail.

A step of preparing an oligomer may include reacting the fluorine-based aromatic diamine and the aromatic diacid dichloride and purifying and drying the obtained oligomer.

In this case, the fluorine-based aromatic diamine may be introduced at a mole ratio of 1.01 to 2 with respect to the aromatic diacid dichloride to prepare an amine-terminated polyamide oligomer. A molecular weight of the oligomer is not particularly limited, but for example, when the weight average molecular weight is in a range of 1000 to 3000 g/mol, better physical properties may be obtained. Here, a side reaction may be suppressed by polymerizing the oligomer in the presence of pyridine to prepare a resin having better physical properties.

In addition, it is preferred to use an aromatic carbonyl halide monomer such as terephthaloyl chloride or isophthaloyl chloride, not terephthalic ester or terephthalic acid itself for introducing an amide structure, and it is because a chlorine element has an influence on the physical properties of the film.

Next, a step of preparing an polyamic acid may be performed by a solution polymerization reaction in which the thus-prepared oligomer is reacted with the fluorine-based aromatic diamine, the aromatic dianhydride, and the cycloaliphatic dianhydride in an organic solvent. Here, the organic solvent used for the polymerization reaction may be, as an example, any one or two or more polar solvents selected from dimethylacetamide (DMAc), N-methyl-2-pyrrolidone (NMP), dimethylformamide (DMF), dimethylformsulfoxide (DMSO), ethyl cellosolve, methyl cellosolve, acetone, diethyl acetate, m-cresol, and the like.

Next, a step of carrying out imidization to prepare a polyamide-imide resin may be carried out by chemical imidization, and more preferably, a polyamic acid solution is chemically imidized using pyridine and an acetic anhydride. Subsequently, imidization may be carried out using an imidization catalyst and a dehydrating agent at a low temperature of 150° C. or lower, preferably 100° C. or lower, and more specifically 50 to 150° C.

With the chemical imidization, uniform mechanical physical properties may be imparted to the entire film as compared with the case of an imidization reaction by heat at a high temperature.

As the imidization catalyst, any one or two or more selected from pyridine, isoquinoline, and β-quinoline may be used. In addition, as the dehydrating agent, any one or two or more selected from an acetic anhydride, a phthalic anhydride, a maleic anhydride, and the like may be used, but the present invention is not necessarily limited thereto.

In addition, an additive such as a flame retardant, an adhesion improver, inorganic particles, an antioxidant, a UV inhibitor, and a plasticizer may be mixed with the polyamic acid solution to prepare the polyamide-imide resin.

In addition, after the imidization, the resin is purified using a solvent to obtain a solid content, which may be dissolved in a solvent to obtain a polyamide-imide solution. The solvent may include, for example, N,N-dimethyl acetamide (DMAc) and the like, but is not limited thereto.

In the present invention, a weight average molecular weight of the polyamide-imide resin is not particularly limited, but may be 200,000 g/mol or more, preferably 300,000 g/mol or more, and more preferably 300,000 to 400,000 g/mol. In the range, a film having a high modulus, an excellent restoring force even with long-term bending, and excellent mechanical strength, and being less curled may be provided, which is thus preferred.

<Method of Producing Film>

Hereinafter, a method of producing a polyimide-based film having the properties of the present invention will be illustrated.

In an exemplary embodiment of the present invention, the transparent polyimide of the present invention is cast on a substrate using a solution, and the film is peeled off from the substrate in a state in which 15-30 wt % of a residual solvent remains.

Subsequently, the peeled off film is stretched to 1.01 to 1.5 times in an MD direction (film progress direction) at a temperature of 150° C. or lower, the film is fixed with a clip using a pin tenter, and then is secondarily dried while preventing shrinkage to impart an additional stretching effect. During the second drying, the film is dried to a solvent content of 5 wt % or less, preferably 3 wt % or less, and more preferably 0.5 wt % or less.

During the first stretching, stretching may be performed in two or more stretching sections, and the temperature is raised in the next section rather than in the first stretching section and a stretch ratio may be increased. In addition, a stretching temperature in the first stretching may be 150° C. or lower.

In an exemplary embodiment, the stretching may be performed in two stretching sections; stretching to 105 to 109% at 90 to 120° C. is performed in the first stretching section and stretching to 110 to 115% at 120 to 150° C. is performed in the second stretching section.

In an exemplary embodiment, the stretching may be performed in three stretching sections; stretching to 101 to 104% at 70 to 90° C. is performed in the first stretching section, stretching to 105 to 109% at 90 to 120° C. is performed in the second stretching section, and stretching to 110 to 115% at 120 to 150° C. is performed in the third stretching section. In addition, the temperature is gradually raised from the first stretching section to the third stretching section, and it is preferred that the stretching ratio is increased.

In addition, during the second drying, a step of fixing the film using a jig in the form of a clip or pin for suppressing shrinkage without additional stretching in a TD direction (a direction perpendicular to a film progress direction), thereby imparting a stretching effect in a TD direction, is performed. More specifically, it is preferred that a drying temperature is maintained at 200° C. to 300° C., and during the dry at 300° C. to 350° C., it is preferred to dry at an oxygen concentration of 1% or less under a N₂ atmosphere.

Subsequently, the film is heat-treated at around a temperature of glass transition temperature (T_{g})±30° C. for 10 seconds to 10 minutes, thereby producing a polyimide film having the properties of the present invention.

By using the polyimide resin and adopting the production method, in the present invention, a film to be desired in the present invention, which has a modulus of 5.0 GPa or more, plastically deforms at a strain of 4% or more during stretching, and has a modulus difference between MD and TD of 0.7 GPa or less, may be obtained.

In addition, by using the polyimide resin and adopting the production method, a film having a modulus of 5.0 GPa or more, plastic deformation occurring at a strain of 4% or more during stretching, a modulus difference between MD and TD of 0.7 GPa or less, and a stress at the time of plastic deformation occurrence of 1000 kgf/cm² or more, preferably 1500 kgf/cm² or more, and more preferably 2000 kgf/cm² or more may be obtained, and thus, the restoring force to be desired in the present invention may be obtained.

More preferably, by using the polyimide resin and adopting the production method, a film having a modulus of 5.0 GPa or more, plastic deformation occurring at a strain of 4% or more during stretching, a modulus difference between MD and TD of 0.7 GPa or less, a stress at the time of plastic deformation occurrence of 1000 kgf/cm² or more, preferably 1500 kgf/cm² or more, and more preferably 2000 kgf/cm² or more, and an amount of energy required per a unit thickness μm at a point of plastic deformation occurrence of 30 J/m² or more, preferably 30 to 100 J/m², in a stress-strain curve measured using a universal testing machine (UTM), may be obtained, and thus, the restoring force to be desired in the present invention may be obtained.

More specifically, a film having an excellent restoring force, which, as shown in FIG. 1, when being fixed to a folding tester (YUASA SYSTEMS CO., LTD.) using an adhesive, maintained under an environment of 25° C./50% RH for 240 hours in a state of being folded with a folding radius (R₁ of FIG. 1) set to 3 mm, and then unfolded, may return to its original state without being folded again in the folded part or causing deformation, may be obtained.

Accordingly, the film of the present invention has very good properties as a window cover film for foldable and flexible devices, to show a significantly improved state of restoration when being maintained in a state of being folded for a long time and then unfolded.

In an exemplary embodiment of the present invention, the polyimide-based film may have a modulus in accordance with ASTM D882 of 5 GPa or more, 6 GPa or more, or 7 GPa or more, an elongation at break of 8% or more, 12% or more, 15% or more, and more preferably 19% or more, a light transmittance of 5% or more or 5 to 80% as measured at 388 nm in accordance with ASTM D1746, a total light transmittance of 87% or more, 88% or more, or 89% or more as measured at 400 to 700 nm, a haze according to ASTM D1003 of 2.0% or less, 1.5% or less, or 1.0% or less, a yellow index in accordance with ASTM E313 of 5.0 or less, 3.0 or less, or 0.4 to 3.0, and a b* value of 2.0 or less, 1.3 or less, or 0.4 to 1.3.

In the present invention, a polyimide solution for forming a film may be prepared by preparing polyamide-imide, purifying the polyamide-imide, and dissolving the polyamide-imide in a solvent such as N,N-dimethyacetamide (DMAc).

That is, the film may be produced by applying the polyamide-imide solution (also referred to as a polyimide solution) on a substrate and then using steps of drying, stretching and heat treatment, and the substrate on which the solution is cast is not particularly limited and for example, glass, stainless steel, or another substrate film may be used, but is not limited thereto. Application of the polyamide-imide of the present invention on the substrate may be carried out by a die coater, an air knife, a reverse roll, a spray, a blade, casting, gravure, spin coating, and the like, but a common solution casting method may be used without limitation.

The solvent is not particularly limited as long as it may dissolve a polyimide resin or a polyamide-imide resin; however, for example, may be any one or a mixture of two or more selected from dimethylacetamide (DMAc), N-methyl-2-pyrrolidone (NMP), dimethylformamide (DMF), dimethylformsulfoxide (DMSO), acetone, diethylacetate, m-cresol, and the like, but is not limited thereto.

Another exemplary embodiment of the present invention provides a window cover film including: the polyimide-based film described above; and a coating layer formed on the polyimide-based film.

When the coating layer is laminated on the polyimide-based film having a certain range of a surface hardness change rate, a window cover film having significantly improved visibility may be provided.

According to an exemplary embodiment of the present invention, the coating layer is for imparting functionality of the window cover film, and may be variously applied depending on the purpose.

Specifically, for example, the coating layer may include any one or more layers selected from a hard coating layer, an antistatic layer, a restoration layer, a shock spread layer, a self-cleaning layer, an anti-fingerprint layer, an anti-scratch layer, a low-refractive layer, an shock absorption layer, and the like, but is not limited thereto.

Even in the case in which various coating layers are formed on the polyimide-based film, a window cover film having excellent display quality, high optical properties, and a significantly reduced rainbow phenomenon may be provided, and a window cover film having a restoring force to be desired in the present invention which is better than a basic film or having a restoring force of the category may be provided.

In an exemplary embodiment of the present invention, specifically, the coating layer may be formed on one surface or both surfaces of the polyimide-based film. For example, the coating layer may be disposed on an upper surface of the polyimide-based film, or disposed on each of an upper surface and a lower surface of the polyimide-based film. The coating layer may protect the polyimide-based film having excellent optical and mechanical properties from external physical or chemical damage.

In an exemplary embodiment of the present invention, the coating layer may have a solid content of 0.01 to 200 g/m², with respect to a total area of the polyimide-based film. Specifically, the solid content may be 20 to 200 g/m², based on the total area of the polyimide-based film. By providing the basis weight described above, surprisingly, the film may not cause a rainbow phenomenon while maintaining functionality to implement better visibility.

In an exemplary embodiment of the present invention, specifically, the coating layer may be formed by applying the coating layer in the state of a composition for forming a coating layer including a coating solvent on the polyimide-based film.

The coating solvent is not particularly limited, but preferably, may be a polar solvent. For example, the polar solvent may be any one or more solvents selected from ether-based solvents, ketone-based solvents, alcohol-based solvents, amide-based solvents, sulfoxide-based solvents, aromatic hydrocarbon-based solvents, and the like. Specifically, the polar solvent may be any one or more solvents selected from dimethylacetamide (DMAc), N-methyl-2-pyrrolidone (NMP), dimethylformamide (DMF), dimethylformsulfoxide (DMSO), acetone, diethylacetate, propylene glycol methyl ether, m-cresol, methanol, ethanol, isopropanol, butanol, 2-methoxyethanol, methylcellosolve, ethylcellosolve, methyl ethyl ketone, methyl butyl ketone, methyl isobutyl ketone, methyl phenyl ketone, diethyl ketone, dipropyl ketone, cyclohexanone, hexane, heptane, octane, benzene, toluene, xylene, and the like.

In an exemplary embodiment of the present invention, as a method of forming the coating layer by applying the composition for forming a coating layer on the polyimide-based film, any one or more methods selected from a spin coating method, a dipping method, a spraying method, a die coating method, a bar coating method, a roll coater method, a meniscus coating method, a flexo printing method, a screen printing method, a bead coating method, an airknife coating method, a reverse roll coating method, a blade coating method, a casting coating method, a gravure coating method, and the like, may be used, but is not limited thereto.

Preferably, in an exemplary embodiment of the present invention, the coating layer may be a hard coating layer. The hard coating layer may include any one or more selected from organic materials, inorganic materials, and the like.

For example, the organic material includes carbon, and may include mainly carbon and any one or more selected from nonmetallic elements such as hydrogen, oxygen, and nitrogen.

The inorganic material refers to a material other than the organic material, and may include any one or more selected from metal elements such as alkali earth metals, alkali metals, transition metals, post transition metals, and metalloids. As an example, the inorganic material may include carbon dioxide, carbon monoxide, diamond, carbonates, and the like, as a subject for exception.

In an exemplary embodiment of the present invention, the hard coating layer may be a single layer of an organic material layer or an inorganic material layer, or a mixed layer of an organic material and an inorganic material, and though it is not particularly limited, preferably, may include 10 to 90 wt % of the organic material and 10 to 90 wt % of the inorganic material. Preferably, the hard coating layer may include 40 to 80 wt % of the organic material and 20 to 60 wt % of the inorganic material. Even in the case in which the hard coating layer including the organic material and the inorganic material is formed as described above, bonding with the polyimide-based film is excellent, no light distortion occurs, and in particular, an effect of improving a rainbow phenomenon is better.

According to an exemplary embodiment of the present invention, though not particularly limited, the hard coating layer may be a layer including, for example, any one or more polymers selected from an acryl-based polymer, a silicon-based polymer, an epoxy-based polymer, an urethane-based polymer, and the like.

Specifically, the hard coating layer prevents deterioration of optical properties when being formed on the polyimide-based film, and may be a layer formed from a composition for forming a coating layer including an epoxysilane resin for improving a surface hardness. Specifically, the epoxysilane resin may be a siloxane resin including an epoxy group. The epoxy group may be a cyclic epoxy group, an aliphatic epoxy group, an aromatic epoxy group, or a mixture thereof. The siloxane resin may be a polymer compound in which a silicon atom and an oxygen atom form a covalent bond.

Preferably, for example, the epoxy siloxane resin may be a silsesquioxane resin. Specifically, the epoxy siloxane resin may be a compound in which a silicon atom of a silsesquioxane compound is directly substituted by an epoxy group or the substituent on the silicon atom is substituted by an epoxy group. As a non-limiting example, the epoxy siloxane resin may be a silsesquioxane resin substituted by a 2-(3,4-epoxycyclohexyl) group or a 3-glycidoxy group.

The epoxy siloxane resin may be produced from alkoxysilane having an epoxy group alone or hydrolysis and condensation reactions of between alkoxysilane having an epoxy group and another kind of alkoxysilane, in the presence of water. In addition, the epoxysilane resin may be formed by polymerizing a silane compound including an epoxycyclohexyl group.

For example, the alkoxysilane compound having an epoxy group may be any one or more selected from 2-(3,4-epoxycyclohexyl)ethyltrimethoxysilane, 2-(3,4-epoxycyclohexyl)ethyltriethoxysilane, 3-glycidoxypropyltrimethoxysilane, and the like.

In an exemplary embodiment of the present invention, the epoxy siloxane resin may have a weight average molecular weight of 1,000 to 20,000 g/mol, but is not limited thereto. When the epoxy siloxane resin has the weight average molecular weight in the above range, it has an appropriate viscosity, thereby improving flowability, coatability, curing reactivity, and the like of the composition for forming a coating layer, and improving the surface hardness of the hard coating layer.

In an exemplary embodiment of the present invention, the epoxy siloxane resin may be included at 20 to 65 wt %, preferably 20 to 60 wt %, with respect to a total weight of the composition for forming a coating layer. When the epoxy siloxane resin is included in the above range, the surface hardness of the hard coating layer may be improved, and uniform curing may be derived to prevent physical defects such as cracks due to partial overcuring.

In an exemplary embodiment of the present invention, the composition for forming a coating layer may further include a crosslinking agent and an initiator.

Specifically, the crosslinking agent is not particularly limited as long as it may form a crosslink with the epoxy siloxane resin to solidify the composition for forming a coating layer and improve a hardness of the hard coating layer, but the crosslinking agent may be, for example, any one or more selected from (3,4-epoxycyclohexyl)methyl-3′,4′-epoxycyclohexanecarboxylate, diglycidyl 1,2-cyclohexanedicarboxylate, 2-(3,4-epoxycyclohexyl-5,5-spiro-3,4-epoxy)cyclohexane-meta-dioxane, bis(3,4-epoxycyclohexylmethyl)adipate), bis(3,4-epoxy-6-methylcyclohexyl)adipate, 3,4-epoxy-6-methylcyclohexylmethyl-3′,4′-epoxy-6′-methylcyclohexanecarboxylate, 1,4-cyclohexanedimethanol bis(3,4-epoxycyclohexanecarboxylate), ethylenebis(3,4-epoxycyclohexanecarboxylate), 3,4-epoxycyclohexylmethyl(meth)acrylate, bis(3,4-epoxycyclohexylmethyl)adipate, 4-vinylcyclohexenedioxide, vinylcyclohexenemonoxide, 1,4-cyclohexanedimethanol diglycidyl ether, 2,2′-((1-methylethylidene)bis(cyclohexane-4,1-diyloxymethylene))bisoxirane, and the like. Preferably, the crosslinking agent may be any one or more selected from (3,4-epoxycyclohexyl)methyl-3′,4′-epoxycyclohexanecarboxylate, bis(3,4-epoxycyclohexylmethyl)adipate), and the like including a compound in which two 3,4-epoxycyclohexyl groups are connected.

In an exemplary embodiment of the present invention, the content of the crosslinking agent is not particularly limited, and for example, may be 5 to 150 parts by weight, with respect to 100 parts by weight of the epoxy siloxane resin. In addition, according to an exemplary embodiment of the present invention, the crosslinking agent may be included at 3 to 30 wt %, and preferably 5 to 20 wt %, with respect to the total weight of the composition for forming a coating layer. Within the range, the coatability and curing reactivity of the composition for forming a coating layer may be further improved.

In an exemplary embodiment of the present invention, the initiator may be a photoinitiator or a thermal initiator. Preferably, the initiator may be a photoinitiator, and for example, the photoinitiator may include a photo-cationic initiator. The photo-cationic initiator may initiate polymerization of the epoxy siloxane resin and an epoxy-based monomer.

Specifically, the photo-cationic initiator may be any one or more selected from onium salts, organic metal salts, and the like, but is not limited thereto. For example, the photo-cationic initiator may be any one or more selected from a diaryliodonium salt, a triarylsulfonium salt, an aryldiazonium salt, an iron-arene complex, and the like, but is not limited thereto.

In an exemplary embodiment of the present invention, the content of the photoinitiator is not particularly limited, and for example, may be 1 to 15 parts by weight, with respect to 100 parts by weight of the epoxy siloxane resin. In addition, according to an exemplary embodiment of the present invention, the crosslinking agent may be included at 0.1 to 10 wt %, and preferably 0.3 to 5 wt %, with respect to the total weight of the composition for forming a coating layer. When the content of the photoinitiator is within the above range, curing efficiency of the hard coating layer is better and deterioration of the physical properties due to residual components after curing may be further prevented.

In an exemplary embodiment of the present invention, the composition for forming a coating layer may further include any one or more additives selected from fillers, slip agents, photostabilizers, thermal polymerization prohibition agents, leveling agents, lubricants, antifoulants, thickeners, surfactants, antifoaming agents, anti-static agents, dispersants, initiators, coupling agents, antioxidants, UV stabilizers, colorants, and the like, but it not limited thereto.

The hard coating layer may further include inorganic particles for imparting hardness. The inorganic particles may be preferably silica, and more preferably surface-treated silica, but are not limited thereto. Here, a surface treatment may include of a functional group capable of reacting with the crosslinking agent described above.

According to an exemplary embodiment, the inorganic particles may have an average particle diameter of 1 to 500 nm, and preferably 10 to 300 nm, but are not limited thereto.

It is seen that when the hard coating layer is formed on the conventional polyimide-based film, a sufficient restoring force is not shown, but the window cover film of the present invention has a sufficiently excellent restoring force. In addition, the window cover film may have excellent visibility and mechanical physical properties.

Another exemplary embodiment of the present invention provides a display device including: a display panel and the window cover film described above formed on the display panel.

In an exemplary embodiment of the present invention, the display device is not particularly limited as long as it belongs to a field requiring excellent optical properties, and may be provided by selecting a display panel appropriate therefor. Preferably, the window cover film may be applied to a flexible display device, and specifically, for example, may be included and applied to any one or more image displays selected from various image displays such as a liquid crystal display, an electroluminescence display, a plasma display, and a field emission display device, but is not limited thereto.

The display device including the window cover film of the present invention described above has excellent display quality to be displayed and significantly decreased distortion caused by light, and thus, may have a significantly improved rainbow phenomenon in which iridescent stain occurs and minimize user's eye strain with excellent visibility.

Hereinafter, the present invention will be described in more detail with reference to the Examples and Comparative Examples. However, the following Examples and Comparative Examples are only an example for describing the present invention in more detail, and do not limit the present invention in any way.

1) Evaluation of Restoring Force

When a film was fixed to a folding tester (YUASA SYSTEMS CO., LTD.) using an adhesive, as shown in FIG. 1, maintained under an environment of 25° C./50% RH for 240 hours in a state of being folded with a folding radius (R₁ of FIG. 1) set to 3 mm, and then unfolded, it was evaluated whether film could return to its original state without being folded again in the folded part or causing deformation. Here, the film was evaluated after being cut into a size of 100 mm×50 mm, and a load at the time of folding was 1 kgf.

Good: When visually confirmed, there was no visual appearance change in the folded part and warpage of less than 2 mm in a bent direction occurred.

Normal: When the folded part was visually confirmed, appearance change (folded mark) was visually confirmed and when the film was placed on a flat place, warpage of 2 mm to 5 mm in a bent direction occurred.

Poor: Including the cases in which the film is maintained in a state of being bent of more than 5 mm in a bent direction or is not restored.

2) Modulus and Elongation at Break

In accordance with ASTM D882, the elongation at break was measured using UTM 3365 available from Instron, under the condition of pulling a polyamide-imide film having a length of 50 mm and a width of 10 mm at 50 mm/min at 25° C. The thickness of the film was measured and the value was input to the instrument. The unit of the modulus was GPa and the unit of the elongation at break was %.

3) Amount of Energy Per Unit Thickness (Elastic Energy)

An amount of energy per a unit thickness (elastic energy) was determined as (stress×deformed length)/2 at a yield point (elastic-plastic deformation transition point) in a S-S curve, when measurement was performed under conditions of pulling a polyamide-imide film having a length of 50 mm and a width of 10 mm at 50 mm/min at 25° C., using UTM 3365 from Instron, in accordance with ASTM D882. The unit was J/m²/μm.

4) Light Transmittance

In accordance with the standard of ASTM D1746, a total light transmittance was measured at the entire wavelength area of 400 to 700 nm using a spectrophotometer (from Nippon Denshoku, COH-400) and a single wavelength light transmittance was measured at 388 nm using UV/Vis (Shimadzu, UV3600), on a film having a thickness of 50 μm. The unit was %.

5) Haze

In accordance with the standard of ASTM D1003, the haze was measured using a spectrophotometer (from Nippon Denshoku, COH-400), on a film having a thickness of 50 μm. The unit was %.

6) Yellow Index (YI)

In accordance with the standard of ASTM E313, the yellow index and the b* value were measured based on a film having a thickness of 50 μm, using a colorimeter (from HunterLab, ColorQuest XE).

7) Weight Average Molecular Weight (Mw) and Polydispersity Index (PDI)

The weight average molecular weight and the polydispersity index of the produced films were measured as follows.

First, a film sample was dissolved in a DMAc eluent containing 0.05 M LiBr and used as a sample. Measurement was performed by using GPC (Waters GPC system, Waters 1515 isocratic HPLC Pump, Waters 2414 Refractive Index detector), connecting Olexis, polypore, and mixed D columns as a GPC column, using a DMAc solution as a solvent, and using polymethylmethacrylate (PMMA STD) as a standard, and analysis was performed at a flow rate of 1 mL/min at 35° C.

8) Pencil Hardness

For the films produced in Examples and Comparative Examples, according to JIS K5400, a line of 20 mm was drawn at a rate of 50 mm/sec on the film using a load of 750 g, this operation was repeated 5 times or more, and the pencil hardness was measured based on the case in which scratches occurred once or less.

9) Measurement of Residual Solvent Content

For a residual solvent content, a value obtained by subtracting a weight at 370° C. from a weight at 150° C. using TGA (Discovery from TA) was determined as a residual solvent content in the film. Here, measurement conditions were heating up to 400° C. at a heating rate of 10° C./min and a weight change in a region from 150 to 370° C. was measured.

### Preparation Example 1 Preparation of Composition for Forming Polyimide-Based Film

Terephthaloyl dichloride (TPC) and 2,2′-bis(trifluoromethyl)-benzidine (TFMB) were added to a mixed solution of dichloromethane and pyridine in a reactor, and stirring was performed at 25° C. for 2 hours under a nitrogen atmosphere. Here, a mole ratio of TPC:TFMB was adjusted to 300:400, and a solid content was adjusted to 10 wt %. Thereafter, the reactant was precipitate in an excessive amount of methanol and then filtration was performed to obtain a solid content, which was dried under vacuum at 50° C. for 6 hours or more to obtain an oligomer, and the prepared oligomer had a formula weight (FW) of 1670 g/mol.

N,N-dimethylacetamide (DMAc), 100 mol of the oligomer, and 28.6 mol of 2,2′-bis(trifluoromethyl)-benzidine (TFMB) were added to the reactor and sufficient stirring was performed. After confirming that the solid raw material was completely dissolved, fumed silica (surface area of 95 m²/g, <1 μm) was added to DMAc at a content of 1000 ppm relative to the solid content, and added to the reactor after being dispersed using ultrasonic waves. 64.3 mol of cyclobutanetetracarboxylic dianhydride (CBDA) and 64.3 mol of 4,4′-hexafluoroisopropylidene diphthalic anhydride (6FDA) were subsequently added, sufficient stirring was performed, and the mixture was polymerized at 40° C. for 10 hours. Here, the solid content was 12%. Subsequently, each of pyridine and acetic anhydride was added to the solution at 2.5-fold relative to the total content of dianhydride, and stirring was performed at 60° C. for 12 hours.

After the polymerization was completed, the polymerization solution was precipitated in an excessive amount of methanol and filtered to obtain a solid content, which was dried under vacuum at 50° C. for 6 hours or more to obtain polyamide-imide powder. The powder was diluted and dissolved at 20 wt % in DMAc to prepare a polyimide-based resin solution. The thus-prepared polyimide had a weight average molecular weight of 320,000 g/mol and a polydispersity (PDI) of 2.22.

### Example 1

The composition for forming a polyimide-based film prepared from Preparation Example 1 was coated on a glass substrate using an applicator, dried in a vacuum oven at 80° C. for 30 minutes and at 100° C. for 1 hour, subjected to a first heat treatment at 250 to 300° C. for 2 hours stepwise, and cooled to room temperature to produce a film. The produced film had a residual solvent content of 17 wt %.

Subsequently, the dried film was separated, and a substrate film was stretched to 1.03 times in an MD direction at 80° C. and then to 1.05 times and 1.08 times, respectively at 100° C. and 130° C., sequentially, before being fixed to a pin tenter. Thereafter, the film was fixed with a clip using the pin tenter, and then dried in a dry section at 260° C. Here, an additional stretching effect was imparted by preventing shrinkage during drying. After drying, the film had a glass transition temperature (T_{g}) of 320° C., and then was subjected to a heat treatment at the same temperature as the glass transition temperature for 5 minutes. The finally produced film had a solvent content of 0.7 wt %, and the physical properties thereof are listed in Table 1.

The film had a thickness of 48 μm, a transmittance at 388 nm of 13%, a total light transmittance of 90.5%, a haze of 0.3%, a yellow index (YI) of 2.7, a b* value of 0.9, a modulus of 6.5 GPa, an elongation at break of 21.2%, and a pencil hardness of HB/750 g. In addition, the physical properties related to a restoring force are shown in the following Table 1.

### Examples 2 and 3

Films were produced in the same manner as in Example 1, except that a solvent content, stretching conditions, and heat treatment conditions were changed as shown in the following Table 1.

The physical properties of the film were measured, and are shown in the following Table 1.

### Comparative Example 1

As shown in the following Table 1, the composition for forming a polyimide-based film prepared from Preparation Example 1 was coated on a glass substrate using an applicator, dried in a vacuum oven at 80° C. for 30 minutes and at 100° C. for 1 hour, subjected to a first heat treatment at 250 to 300° C. for 2 hours stepwise, and cooled to room temperature to produce a film.

### Comparative Example 2

A film was produced in the same manner as in Example 1, except that the film was loosely fixed to a tenter so that the film shrank by 5% in a drying process in the second drying. The results are shown in the Table 1.

### Comparative Example 3

A film was produced in the same manner as in Example 1, except that third stretching in an MD direction was carried out at 200° C. The results are shown in the Table 1.

### Comparative Example 4

A film was produced in the same manner as in Example 1, except that stretching in an MD direction was carried out by fixing at 160° C. sequentially. The results are shown in the Table 1.

### Comparative Example 5

A film was produced in the same manner as in Example 1, except that the heat treatment was carried out at T_{g} of 230° C. The results are shown in the Table 1.

### Comparative Example 6

A film was produced in the same manner as in Example 1, except that no heat treatment was carried out. The results are shown in the Table 1.

TABLE 1

| | | Examples | | | Comparative Example | | | | | |
|---|---|---|---|---|---|---|---|---|---|---|
| | | 1 | 2 | 3 | 1 | 2 | 3 | 4 | 5 | 6 |
| Residual solvent | | 17 | 17 | 17 | 17 | 23 | 17 | 18 | 17 | 19 |
| content before | | | | | | | | | | |
| stretching (%) | | | | | | | | | | |
| Stretch- | First | 1.03 | 1.05 | 1.05 | — | 1.03 | 1.03 | 1.03 | 1.03 | 1.03 |
| ing (MD) | stretch | | | | | | | | | |
| | ratio | | | | | | | | | |
| | Stretching | 80° C. | 75° C. | 120° C. | | 80° C. | 80° C. | 160° C. | 80° C. | 80° C. |
| | temperature | | | | | | | | | |
| | (° C.) | | | | | | | | | |
| | Second | 1.05 | 1.05 | 1.10 | | 1.05 | 1.05 | 1.05 | 1.05 | 1.05 |
| | stretch | | | | | | | | | |
| | ratio | | | | | | | | | |
| | Stretching | 100° C. | 120° C. | 150° C. | | 100° C. | 100° C. | 160° C. | 100° C. | 100° C. |
| | temperature | | | | | | | | | |
| | (° C.) | | | | | | | | | |
| | Third | 1.08 | 1.08 | — | | 1.08 | 1.08 | 1.08 | 1.08 | 1.08 |
| | stretch | | | | | | | | | |
| | ratio | | | | | | | | | |
| | Stretching | 130° C. | 120° C. | | | 130° C. | 200° C. | 160° C. | 130° C. | 130° C. |
| | temperature | | | | | | | | | |
| | (° C.) | | | | | | | | | |
| Second | TD fixation | 260 | 280 | 300 | 260 | 260 (5% | 260 | 260 | 230 | 280 |
| drying | (° C.) | | | | | shrinkage) | | | | |
| Heat treatment (° C.) | | 320 | 335 | 350 | 320 | 330 | 340 | 350 | 270 | None |
| Modulus | Machine | 6.5 | 6.4 | 6.2 | 4.9 | 5.5 | 6.4 | 6.5 | 6.4 | 6.5 |
| (GPa) | direction | | | | | | | | | |
| | Width | 6.5 | 6.3 | 6.3 | 5.7 | 4.8 | 5.6 | 5.6 | 6.3 | 6.3 |
| | direction | | | | | | | | | |
| Plastic | Strain (%) | 4.2 | 4.3 | 4.3 | 3.6 | 3.8 | 3.9 | 3.9 | 3.2 | 3.1 |
| defor- | Amount of | 42 | 48 | 36 | 29 | 32 | 35 | 33 | 29 | 28 |
| mation | energy | | | | | | | | | |
| | (J/m2/pm) | | | | | | | | | |
| | Stress | 1320 | 1290 | 1350 | 980 | 1240 | 1320 | 1150 | 1210 | 1230 |
| | (kgf/cm2) | | | | | | | | | |

| | | | | | | | | | |
|---|---|---|---|---|---|---|---|---|---|
| Evaluation of | Good | Good | Good | Poor | Normal | Normal | Normal | Poor | Poor |
| restoring force | | | | | | | | | |
| Total light | 90.5 | 90.3 | 90.2 | 90.1 | 90.3 | 90.2 | 90.1 | 89.5 | 89.3 |
| transmittance (%) | | | | | | | | | |
| Light transmittance | 13 | 13 | 13 | 13 | 13 | 13 | 13 | 13 | 13 |
| at 388 nm (%) | | | | | | | | | |
| Haze (%) | 0.3 | 0.3 | 0.4 | 0.4 | 0.35 | 0.5 | 0.4 | 0.3 | 0.4 |
| Yellow index | 2.7 | 2.8 | 3.0 | 2.7 | 2.8 | 2.9 | 3.0 | 1.9 | 1.8 |
| Elongation at | 21.2 | 19.8 | 20.5 | 14.5 | 18.7 | 19.1 | 20.4 | 19.2 | 21.0 |
| break (%) | | | | | | | | | |

The polyimide-based film according to the present invention does not have deformation in a folded part even when being maintained in a state of being folded for a long time and then unfolded, and has no change in optical physical properties.

Accordingly, a polyimide-based film having long-term stability and stable optical physical properties, and a window cover film and a flexible display using the same may be provided.

Hereinabove, although the present invention has been described by specified matters and specific exemplary embodiments, they have been provided only for assisting in the entire understanding of the present invention. Therefore, the present invention is not by the specific matters limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

What is claimed is:

1. A polyimide-based film which has a modulus of 5 GPa or more as measured using a universal testing machine (UTM) in accordance with ASTM D882, plastically deforms at a strain of 4% or more during stretching, and has a difference between a modulus in a machine direction Mmd and a modulus in a width direction Mtd satisfying the following Equation 1:

|Mmd−Mtd|≤0.7 GPa. [Equation 1]

2. The polyimide-based film of claim 1, wherein an amount of energy required per a unit thickness μm of the polyimide-based film is 30 J/m² or more, at a point where plastic deformation occurs, in a stress-strain curve measured using a universal testing machine (UTM).

3. The polyimide-based film of claim 2, wherein the amount of energy required per a unit thickness μm of the polyimide-based film is 30 to 100 J/m².

4. The polyimide-based film of claim 1, wherein a stress of the polyimide-based film is 1000 kgf/cm² or more, at a point where plastic deformation occurs.

5. The polyimide-based film of claim 1, wherein the polyimide-based film has a total light transmittance of 87% or more as measured at 400 to 700 nm in accordance with ASTM D1746, a light transmittance of 5% or more as measured at 388 nm in accordance with ASTM D1746, a haze of 2.0% or less, and a yellow index of 5.0 or less.

6. The polyimide-based film of claim 1, wherein an elongation at break of the polyimide-based film is 15% or more in accordance with ASTM D882.

7. The polyimide-based film of claim 1, wherein the polyimide-based film is formed of a polyamide-imide-based resin.

8. The polyimide-based film of claim 7, wherein the polyimide-based film comprises a unit derived from a fluorine-based aromatic diamine, a unit derived from an aromatic dianhydride, and a unit derived from an aromatic diacid dichloride.

9. The polyimide-based film of claim 8, wherein the polyimide-based film further comprises a unit derived from a cycloaliphatic dianhydride.

10. The polyimide-based film of claim 1, wherein a thickness of the polyimide-based film is 30 to 110 μm.

11. A window cover film comprising:
a polyimide-based film of claim 1; and
a coating layer formed on one surface or both surface of the polyimide-based film.

12. The window cover film of claim 11, wherein the coating layer is any one or more selected from a hard coating layer, an antistatic layer, a restoration layer, an impact spread layer, a self-cleaning layer, an anti-fingerprint layer, an antifouling layer, an anti-scratch layer, a low-refractive layer, an antireflective layer, and impact absorption layer.

13. A flexible display panel comprising the polyimide-based film of claim 1.
